(19) United States
(12) Patent Application Publication
(10) Pub. No.: US 2020/0083706 A1
(43) Pub. Date: Mar. 12, 2020

(54) LITHIUM-ION BATTERY INCLUDING TWO POWER SUPPLIES

(71) Applicant: Briggs & Stratton Corporation, Wauwatosa, WI (US)

(72) Inventors: Andrew J. Paskov, Brookfield, WI (US); Jeffrey M. Zeiler, Wauwatosa, WI (US); Robert Koenen, Pewaukee, WI (US); Daniel Brueck, Brookfield, WI (US); Jason A. Hansen, Elkhorn, WI (US)

(73) Assignee: Briggs & Stratton Corporation, Wauwatosa, WI (US)

(21) Appl. No.: 15/746,790

(22) PCT Filed: Jul. 22, 2016
(86) PCT No.: PCT/US2016/043632

§ 371 Date: Jan. 22, 2018

Related U.S. Application Data
(60) Provisional application No. 62/196,296, filed on Jul. 23, 2015.
(60) Provisional application No. 62/199,209, filed on Jul. 30, 2015.

(51) Int. Cl. H02J 1/10; H02J 7/00; H02J 7/34; H01M 10/0525

(52) U.S. Cl. CPC H02J 1/10; H01M 10/0525; H02J 7/34; H02J 7/0011

(57) ABSTRACT

A battery for equipment having a charging system providing a charging voltage is provided. The battery includes a primary power supply, a secondary power supply, and a battery management system configured to at least one of (a) selectively increase the charging voltage to a boosted voltage and (b) selectively decrease the charging voltage to a bucked voltage, and provide at least one of the boosted voltage and the bucked voltage to the primary power supply.

### CROSS-REFERENCE TO RELATED PATENT APPLICATIONS

This application claims the benefit of U.S. Provisional Application No. 62/196,296, filed Jul. 23, 2015, and the benefit of U.S. Provisional Application No. 62/199,209, filed Jul., 30, 2015 both of which are incorporated herein by reference in their entireties.

### BACKGROUND

The present invention generally relates to electric starting systems for internal combustion engines. Internal combustion engines are utilized in a variety of different applications including outdoor power equipment, vehicles, and other engine driven equipment. More specifically, the present invention relates to internal combustion engines including electric starting systems powered by a rechargeable lithium-ion battery.

Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, by way of example, use an internal combustion engine to drive an implement, such as a rotary blade of a lawn mower, a pump of a pressure washer, the auger of a snowthrower, the alternator of a generator, and/or a drivetrain of the outdoor power equipment. Vehicles include cars, trucks, automobiles, motorcycles, scooters, boats, all-terrain vehicles (ATVs), personal water craft, snowmobiles, utility vehicles (UTVs), and the like. Outdoor power equipment, lawn mowers, riding lawn mowers, snow throwers, vehicles, engine driven equipment, engines and other engine related applications are collectively referred to as “equipment.”

Equipment may include an electric starting system in which a starter motor powered by a battery starts the engine. Typically, such electric starting systems also include a user-actuated starter switch (e.g., a pushbutton or key switch) and a starter solenoid. The starter solenoid is the connection between a low current circuit including the starter switch and a high current circuit including the starter motor. To start the engine, the user actuates the starter switch, causing the starter solenoid to close so that the battery provides starting current to the starting motor to start the engine. In many applications, equipment (particularly, riding lawn mowers) are designed to accept a lead-acid battery having a standard U1 form factor, that has standardized dimensions. As such, a lead-acid battery having a standard U1 form factor can be utilized in a variety of equipment and is readily available for replacement. Typically, the lead-acid battery has a nominal (i.e., operating) voltage of 12.6 volts and a charging voltage of about 14 volts.

In typical applications, the battery is a lead-acid battery. Lead-acid batteries are filled with a liquid electrolyte, typically a mixture of water and sulfuric acid. The electrolyte is corrosive. Lead-acid batteries are temperature sensitive, which may result in the engine having difficulty starting or not starting at all in cold weather. Also, a lead-acid battery will run down with the passage of time and not be able to provide power (i.e., lose charge or become completely discharged—lead acid batteries may lose approximately one percent of charge capacity per day). A lead-acid battery may need to be replaced seasonally, removed from the outdoor power equipment and stored inside, or otherwise maintained or serviced by a user. Infrequent/intermittent use further exacerbates problems inherent to lead-acid batteries. Certain applications (such as outdoor power equipment) that are subjected to substantial temperatures variations and/or infrequent/intermittent use may cause premature failure of lead-acid batteries. A further problem arises with respect to the use of lead acid batteries in equipment. In addition to unintentional battery depletion, equipment is also susceptible to various forms of operator error such as over-cranking the engine. Over-cranking the engine results from an operator attempting to start the engine over a prolonged and constant period of time. In some situations, over-cranking the engine can lead to a failure of the starter motor. The time before over-cranking results in any damage is related to a variety of factors including the voltage and current drawn from the battery, the duration of the engine cranking, the ambient temperature, and the starter motor temperature.

When producing a piece of equipment, a manufacturer often installs a battery into the equipment prior to shipping the equipment to a wholesaler or distributor. The wholesaler or distributer then receives the equipment and stocks the equipment until it is sold. Depending on customer demand, many weeks or months may go by between when the battery is installed by the producer and when it is first used in application. During this time a lead-acid battery charge may significantly deplete requiring the customer to obtain a new battery to use the equipment.

Lithium-ion batteries, particularly oxide-based batteries such as lithium cobalt oxide (LiCoO₂ or LCO) or lithium nickel manganese cobalt oxide (LiNiMnCoO₂ or NMC) batteries, typically are used in applications where they must provide continuous energy output over a relatively long time frame (e.g., to power a laptop computer or to power a power tool). A battery management system may be included within the battery and may block an electrical signal from being delivered to the cells of a battery, or may block a current being drawn from the cells of a battery based the current and voltage properties of the signal and/or of the battery. Lithium-ion cells can come in many configurations including prismatic, pouch, and cylindrical cells. Batteries using other types of lithium-ion battery chemistries, including lithium iron phosphate (LiFePO₄ or LFP) batteries and other phosphate chemistries, are also available.

### SUMMARY

One embodiment of the invention relates to a battery for equipment having a charging system providing a charging voltage. The battery includes a primary power supply, a secondary power supply, and a battery management system configured to at least one of (a) selectively increase the charging voltage to a boosted voltage and (b) selectively decrease the charging voltage to a bucked voltage, and provide at least one of the boosted voltage and the bucked voltage to the primary power supply.

Another embodiment of the invention relates to battery for equipment having a charging system providing a charging voltage. The battery includes a primary power supply including multiple lithium-ion cells and having a charge capacity, a secondary power supply, and a battery management system including a charging voltage compensation module configured to compensate for a difference between the charging voltage and the charge capacity of the primary power supply.

Another embodiment of the invention relates to a battery for equipment including a cell pack and a battery management system. The battery management system is configured to include a voltage circuit and at least one sensor. The voltage circuit is configured to receive an output from the sensor. The voltage circuit is further configured to alter a voltage entering the battery. In some embodiments, the cell pack comprises NMC lithium-ion chemistry cells. In some embodiments, the cell pack comprises cylindrical cells. In some embodiments, the cell pack comprises lithium phosphate lithium-ion chemistry cells. In some embodiments, the battery is in the shape of a standard U1 form factor.

Another embodiment of the invention relates to a starter battery system for an internal combustion engine including a battery management system and a cell pack. The battery management system is configured to include a voltage circuit, a regulator circuit, and at least one sensor. The voltage circuit is configured to receive an output from the sensor. The voltage circuit is further configured to alter a voltage entering the battery. The regulator circuit is configured to produce and output a compensation voltage to an engine regulator. The regulator is further configured to read the compensation voltage and output a correct voltage to the cell pack. In some embodiments, the compensation voltage is greater than the correct voltage. In some embodiments, the compensation voltage is lower than the correct voltage.

Another embodiment of the invention relates to a starter battery for an internal combustion engine including a battery management system and a cell pack. The battery management system is configured to include a voltage circuit, a regulator circuit, a modulating circuit, and at least one sensor. The voltage circuit is configured to receive an output from the sensor. The voltage circuit is further configured to alter a voltage entering the battery. The regulator circuit is configured to produce and output a compensation voltage to a regulator. The regulator is further configured to read the compensation voltage and output a correct voltage to the cell pack. The modulating circuit is configured to control the output voltage of the battery.

Another embodiment of the invention relates to a battery for equipment including a call pack, a battery management system and a second battery system. The voltage circuit is configured to receive an output from the sensor. The voltage circuit is further configured to alter a voltage entering the battery. The regulator circuit is configured to produce and output a compensation voltage to the engine's regulator. The regulator is further configured to read the compensation voltage and output a correct voltage to the cell pack. The modulating circuit is configured to control the output voltage of the battery. In some embodiments, the battery is further configured to include a capacitor pack. In some embodiments, the battery is further configured to include a switch for engaging or disengaging a power saving mode.

Another embodiment of the invention relates to a battery for equipment that includes a terminal, a primary cell pack selectively coupled to the terminal, a secondary cell pack coupled to the terminal and thereby configured to provide an electrical power to an electrical load, and a battery management system including a processing circuit. The processing circuit is configured to: monitor a condition associated with the electrical load, and selectively couple the primary cell pack to the terminal and thereby supplement the electrical power provided by the secondary cell pack in response to the condition at least one of exceeding and falling below a threshold range.

Alternative exemplary embodiments relate to other features and combinations of features as may be generally recited in the claims.

### BRIEF DESCRIPTION OF THE DRAWINGS

FIG. 1 is schematic representation of a riding lawn mower, according to an exemplary embodiment.

FIG. 2A is a perspective view of cylindrical lithium-ion battery cell, according to an exemplary embodiment.

FIG. 2B is a perspective view of a grouping of the battery cell of FIG. 2A.

FIG. 2C is a block diagram of a piece of equipment, according to an exemplary embodiment.

FIG. 3 a block diagram of a piece of equipment, according to an exemplary embodiment.

FIG. 4A is a block diagram of the equipment of FIG. 3, further including a regulator in the charging system.

FIG. 4B is an electrical circuit diagram for boosting or increasing the voltage of a charging system, according to an exemplary embodiment.

FIG. 4C is an electrical circuit diagram for bucking or decreasing the voltage of a charging system, according to an exemplary embodiment.

FIG. 4D is an electrical circuit diagram including an inductor for boosting or increasing the voltage of a charging system, according to an exemplary.

FIG. 5A is a block diagram of the equipment of FIG. 4A, further including a regulator circuit within the battery management system a block diagram of a piece of equipment, according to an exemplary embodiment.

FIG. 5B is an electrical circuit diagram including a battery and a sensor, according to an exemplary embodiment.

FIG. 5C is an electrical circuit for increasing or decreasing the incoming voltage, according to an exemplary embodiment.

FIG. 6A is a block diagram of a piece of equipment, according to an exemplary embodiment.

FIG. 6B is an electrical circuit diagram including a cell pack and a modulating circuit, according to an exemplary embodiment.

FIG. 7 is a block diagram of a piece of equipment, according to an exemplary embodiment.

FIG. 8A is a block diagram of a piece of equipment, according to an exemplary embodiment.

FIG. 8B is an electrical circuit diagram including a battery, sensor, and secondary battery system, according to an exemplary embodiment.

FIG. 9 is a block diagram of a piece of equipment, according to an exemplary embodiment.

FIG. 10A is a block diagram of a piece of equipment, according to an exemplary embodiment.

FIG. 10B is an electrical circuit diagram including a cell pack, monitoring circuit, a heating element, and a processing circuit, according to an exemplary embodiment.

FIG. 11A is an electrical circuit diagram including a boost charge, a processing circuit, and secondary cells, according to an exemplary embodiment.

FIG. 11B is an electrical circuit diagram, according to an exemplary embodiment.

FIG. 11C is an electrical circuit diagram, according to an exemplary embodiment.

FIG. 11D is a block diagram of a piece of equipment, according to an exemplary embodiment.

FIG. 12 is an electrical circuit diagram, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

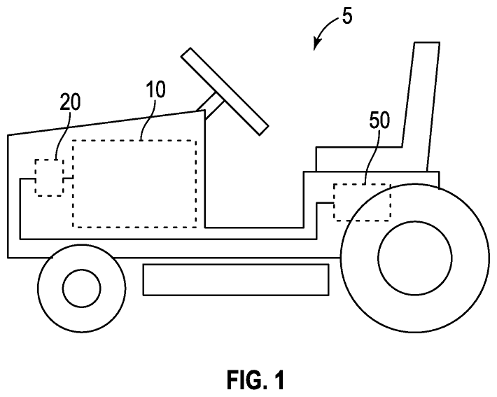

Referring to FIG. 1, a riding lawn tractor 5 is illustrated according to an exemplary embodiment. The tractor 5 includes an internal combustion engine 10, an electric starting motor 20, and a rechargeable battery 50. The battery 50 is used to power the electric starting motor 20 to start the engine 10. The battery 50 does not use lead-acid battery chemistry as in the batteries typically used to power starting motors and other electronic equipment of outdoor power equipment, vehicles, and other engine driven equipment. Instead, as described in more detail below, the battery 50 uses lithium-ion battery cells and/or capacitors to store and provide electrical energy.

The battery 50 may be installed by a manufacturer as original equipment on a lawn tractor or other piece of engine-driven equipment or installed later as a replacement battery. The electrical ratings of the battery 50 differ from those of a lead-acid battery. For example, the nominal voltage and the charging voltage of the battery 50 differ from those of a lead-acid battery. Lawn tractors and other pieces of engine-driven equipment are designed to interact with lead-acid batteries having electrical ratings that are characteristic to lead-acid battery chemistry. For example, the charging voltage supplied by a typical lawn tractor is intended to charge a lead-acid battery and may be either too low or too high to properly charge the battery 50, which uses lithium-ion battery cells. To account for the differences between electrical ratings for the battery 50 and typical lead-acid batteries and to properly interact with engine-driven equipment designed to interact with typical lead-acid batteries, the battery 50 includes one or more systems that compensate for these differences.

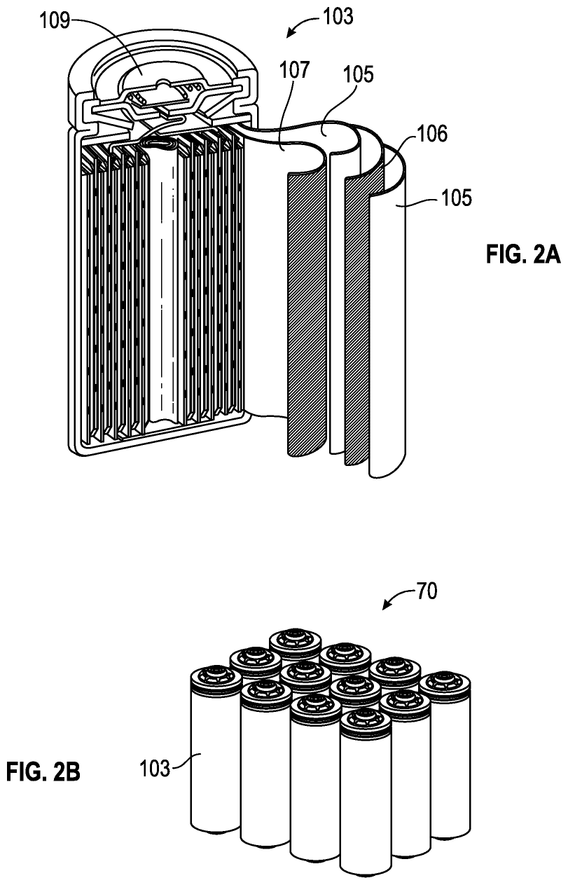

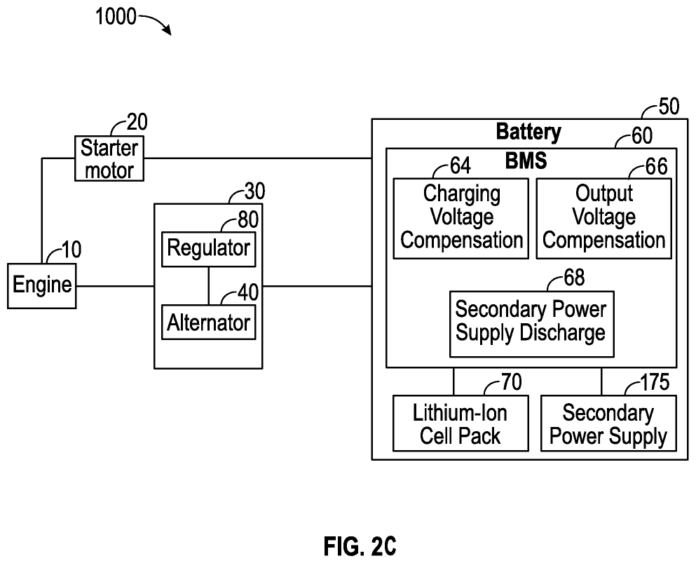

Referring to FIG. 2A, a cylindrical lithium-ion battery cell 103 is illustrated according to an exemplary embodiment. An anode 106 and a cathode 107 are separated by a separator 105. The cylindrical cell 103 includes a positive terminal 109 and a negative terminal 111.

Referring to FIG. 2B, a cell pack 70 including twelve lithium-ion battery cells 103 arranged in is four rows of three cells is illustrated according an exemplary embodiment. In other embodiments, the cell pack is arranged in other configurations including multiple lithium-ion battery cells. The lithium-ion battery cells 103 may be NMC, LFP, LCO, or other suitable lithium-ion battery chemistries. The cells 103 may be 18-650 cells having an 18 millimeter diameter and a 65 millimeter length. According to another exemplary embodiment, “20-650” cells may be utilized having a 20 millimeter diameter and a 65 millimeter length. Other sizes and types of cells may be used, including prismatic and pouch cells. Typically, the cells are configured in a series-parallel configuration, otherwise known as an “S-P” configuration. The cell pack 70 may be categorized by the arrangement of how the cells 103 are connected in series and connected in parallel. By way of example, a battery 50 with three cells 103 arranged in a group or row connected together in series and the three rows connected together in parallel may be termed a 3S-3P battery. The number of cells in series has the most significant impact on the voltage of the battery while the number of rows in parallel has the most significant impact on the capacity of the battery.

By way of example, in some embodiments, the cell pack 70 includes three NMC cells 103 wired in series (3S) with each cell having a 3.65 volt full potential and the cell pack 70 having a 10.95 volt full pack potential and a 12.6 volt charge capacity (maximum full pack potential). In some embodiments, the cell pack 70 includes four NMC cells 103 wired in series (4S) with each cell having a 3.65 volt full potential and the cell pack 70 having a 14.6 volt full pack potential and a 16.8 volt charge capacity (maximum full pack potential). In some embodiments, the cell pack 70 includes four LFP cells 103 wired in series (4S) with each cell having a 3.2 volt full cell potential and the cell pack 70 having a 12.8 volt full pack potential and a 14.4 volt charge capacity (maximum full pack potential).

Referring to FIG. 2C, a piece of engine-driven equipment 1000 is illustrated according to an exemplary embodiment. The equipment 1000 includes an engine 10, a starter motor 20, a charging system 30, and a battery 50. The charging system 30 provides electrical current to charge the battery 50 while the engine 10 is running. In the illustrated embodiment, the charging system 30 includes an alternator 40 and a regulator 80. The alternator 40 is driven by the engine 10 to produce electricity. In some embodiments, the alternator 40 produces electricity having a relatively high AC voltage (e.g. between 27-45 volts). The regulator 80 converts the alternating current from the alternator 80 to direct current. The regulator 80 also controls the output or charging voltage supplied by the charging system 30. For charging systems designed for use with typical lead acid batteries, typically the charging voltage is about 14 to 17 volts. In other embodiments, the regulator 80 is omitted and the alternator 40 supplies a DC voltage as the charging voltage from the charging system 30. In other embodiments, other types of charging systems may be used. By way of example, an ignition coil waste spark plug charging system may be used in which waste sparks from the ignition coil are harvested to provide charging energy in replacement of or in addition to the alternator 40.

The battery 50 includes one or more lithium-ion battery cells 103 arranged as a cell pack 70 or primary power supply. The battery 50 also includes a secondary power supply 175. In some embodiments, the secondary power supply 175 includes one or more lithium-ion battery cells 103 arranged in a cell pack. In other embodiments, the secondary power supply 175 includes one or more capacitors or other energy storage devices.

The charge capacity for the lithium-ion primary power supply 70 is different than charging voltage supplied by the charging system 30 intended for use with a lead-acid battery. In some embodiments, the primary power supply 70 uses a 3S configuration of NMC battery cells 103 and has a charge capacity of 12.6 volts and the charging system supplies a higher voltage (e.g., about 14 to 17 volts with a regulator 80 or higher without). In some embodiments, the primary power supply 70 uses a 4S configuration of NMC battery cells 103 and has a charge capacity of 16.8 volts and the charging system supplies a charging voltage that can be lower or higher (e.g., about 14 to 17 volts with a regulator 80 or higher without). In some embodiments, the primary power supply 70 uses a 4S configuration of LFP battery cells 103 and has a charge capacity of 14.4 volts and the charging system supplies a charging voltage that can be lower or higher (e.g., about 14 to 17 volts with a regulator 80 or higher without). Other types of lithium-ion cells and configurations of the cells may be used in different embodiments. In some embodiments, the battery 50 includes NMC lithium-ion cells 103 in a 4S configuration for the primary power supply 70 (e.g., a 4S2P configuration) and one or more capacitors as the secondary power supply 175 (e.g., two capacitors rated at 10,000 or 12,000 microfarads).

The secondary power supply 175 is provided to compensate for the differences in the charge capacity of the lithium-ion primary power supply 70 and the charging voltage supplied by the charging system 30 intended for use with a lead-acid battery. The secondary power supply 175 serves as a buffer or intermediary between the primary power supply 70 and the charging system 30 so that the overall electrical ratings of the battery 50 resemble those of a lead-acid battery. In embodiments where the charge capacity of the primary power supply 70 is less than the charging voltage supplied by the charging system 30, the secondary power supply 175 receives the excess charging voltage that would otherwise overcharge the primary power supply 70. In embodiments where the charge capacity of the primary power supply 70 is greater than the charging voltage supplied by the charging system 30, the secondary power supply 175 stores charge during operation of the engine 10 and provides a compensation voltage to fully charge the primary power supply 70 that would otherwise be undercharged by the charging voltage provided by the charging system 30.

The use of two power supplies, the primary power supply 70 and the secondary power supply 175, enables the battery 50, which uses lithium-ion battery chemistry, to serve as a direct replacement for a lead-acid battery without requiring changes to the charging system 30 intended for use with a lead-acid battery. This simplifies the use of lithium-ion batteries 50 for manufacturers of original equipment and for end users replacing batteries on the equipment because lithium-ion batteries 50 and lead-acid batteries can be installed on the same equipment without having to change the charging system 30. All compensation for differences in electrical ratings occurs internally within the lithium-ion battery 50 with no changes needed to the charging system or the equipment. Control of the compensation and other operations of the battery 50 is effectuated by a controller or battery management system (BMS) 60. The BMS 60 may include hardware components, software components, or a combination of the two to perform the various control operations described herein.

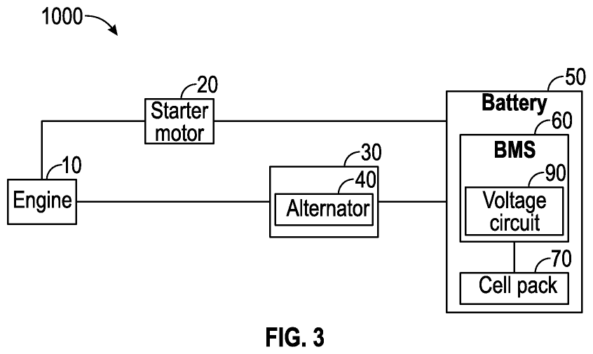

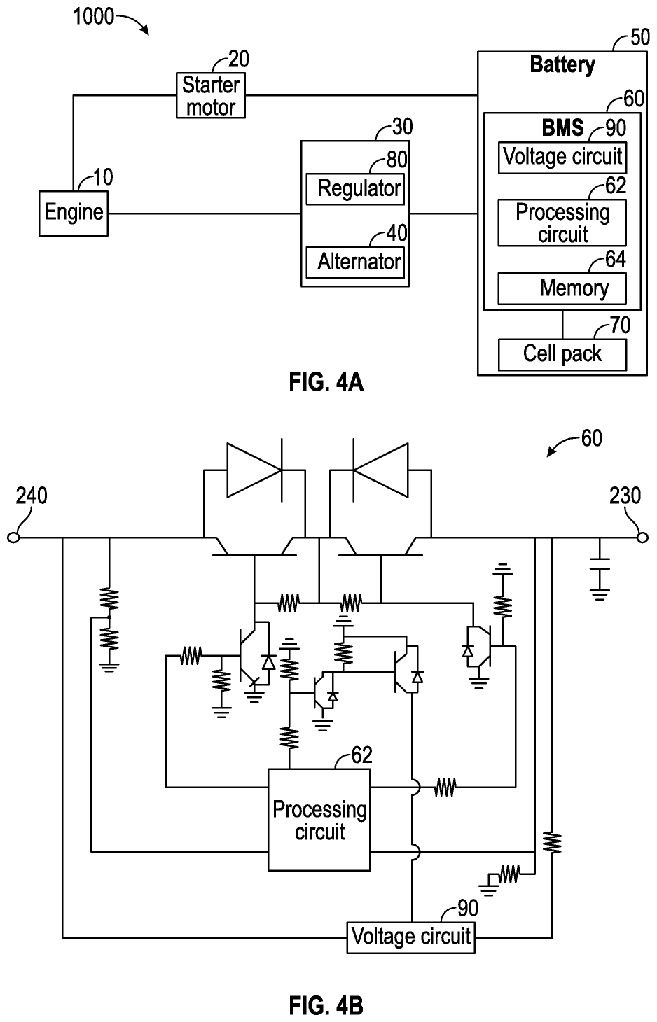

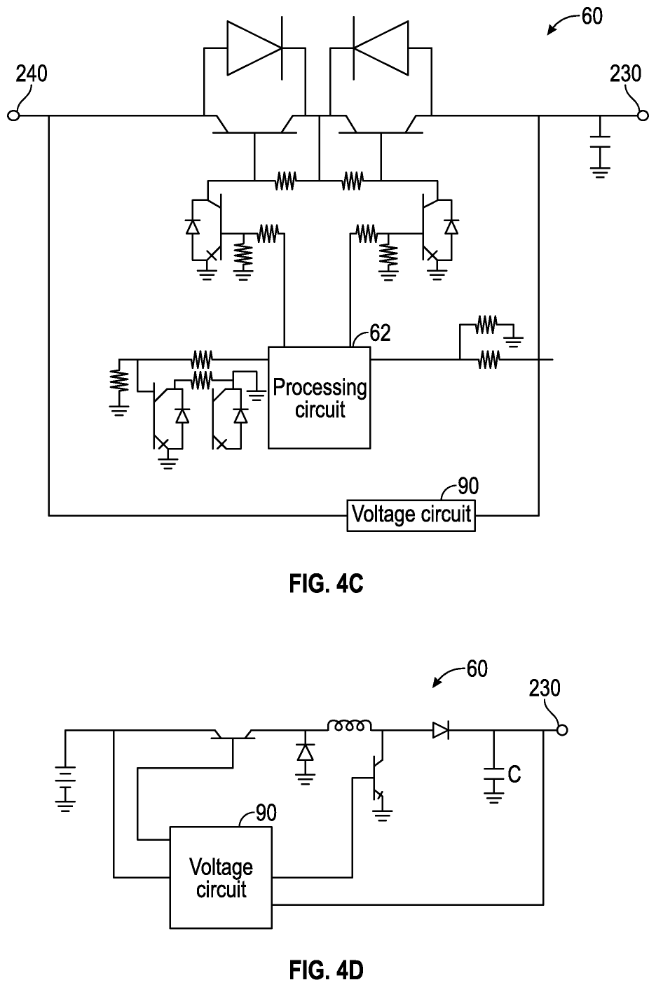

BMS 60 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the embodiment shown in FIGS. 3-4A, BMS 60 includes a processing circuit, a memory, and an input-output interface. The processing circuit may include an ASIC, one or more FPGAs, a DSP, circuits containing one or more processing components, circuitry for supporting a microprocessor, a group of processing components, or other suitable electronic processing components. In some embodiments, BMS 60 is configured to execute computer code stored in the memory to facilitate the activities described herein. The memory may be any volatile or non-volatile computer-readable storage medium capable of storing data or computer code relating to the activities described herein. In one embodiment, the memory has computer code modules (e.g., executable code, object code, source code, script code, machine code, etc.) configured for execution by the processing circuit. In some embodiments, the BMS 60 represents a collection of processing devices. In such cases, the processing circuit represents the collective processors of the devices, and the memory represents the collective storage devices of the devices.

BMS 60 includes a charging voltage compensation module or circuit 64 to control the compensation for the differences in the charge capacity of the lithium-ion primary power supply 70 and the charging voltage supplied by the charging system 30 intended for use with a lead-acid battery. In embodiments where the charge capacity of the primary power supply 70 is less than the charging voltage supplied by the charging system 30, the charging compensation module 64 and the secondary power supply 175 decreases or bucks the charging voltage applies to the primary power supply 70 to a decreased or bucked voltage that is supplied to the primary power supply 70 so as to not overcharge the primary power supply 70. In some embodiments, the voltage supplied to the primary power supply 70 is always the decreased voltage and in other embodiments the voltage supplied to the primary supply is decreased when the primary power supply 70 reaches a threshold voltage or state of charge. The secondary power supply 175 may receive the excess charging voltage that would otherwise overcharge the primary power supply 70.

In embodiments where the charge capacity of the primary power supply 70 is greater than the charging voltage supplied by the charging system 30, the secondary power supply 175 stores charge during operation of the engine 10. The charging compensation module 64 and the secondary power supply 175 provide a compensation voltage that increases or boosts the charging voltage supplied by the charging system 30 to an increased or boosted voltage that is supplied to the primary power supply 70 to fully charge the primary power supply 70 that would otherwise be undercharged by the charging voltage provided by the charging system 30. The secondary power supply 175 is charged during normal, non-starting cycle, operation of the engine by the charging system 30 so as to have sufficient charge to provide the compensation voltage to boost the charging voltage.

BMS 60 may also include an output voltage compensation module or circuit 66 to regulate the output voltage provided by the battery 50. In embodiments where the lithium-ion battery 50 provides an output voltage greater than the voltage the equipment is designed to receive, the output voltage compensation circuit 66 reduces the output voltage to the standard voltage for the equipment. For example, for a primary power supply 70 having a 4S NMC cell configuration, the 16.8 volt output from the battery 50 will be greater than the 12 volt electrical system typically found on equipment powered by a 12.6 volt lead-acid battery. Accordingly, the output voltage compensation circuit 66 uses pulse-width modulation or other voltage reduction technique to match the voltage output from the battery 50 to supply the appropriate voltage to the electrical system of the equipment.

BMS 60 may also include a secondary power supply discharge module or circuit 68 to discharge excess charge from the secondary power supply 175 to prevent overcharging of the secondary power supply 175 by the charging system 30. The secondary power supply discharge circuit 68 activates when the secondary power supply 175 reaches a charge threshold or capacity and discharges excess charge that would otherwise overcharge the secondary power supply 175. The discharge may be routed to a resistor to convert the excess charge to heat.

The BMS 60 may also include circuitry for managing the charge state and voltage applied to the lithium-ion battery 50, and particularly, managing the charge state and voltage applied to the lithium-ion cells 103 and protecting the lithium-ion cells 103 from fault conditions including over and under voltage, over and under voltage, and over and under temperature. By way of example, the BMS 60 may be configured to charge the lithium-ion cells 103 according to a constant-current (CC) and/or a constant-voltage (CV) scheme.

Referring to FIGS. 3-4A, in a 3S NMC cell pack 70, the 12.6 volt charge capacity is less than 14.4-15 volt charge which is the typically generated by electric charging system for a typical lead-acid battery used with outdoor power equipment and other equipment. As such, according to one embodiment, the 3S NMC cell pack utilizes a voltage circuit 90 (e.g., a boosting circuit) to ensure that the electrical system of the equipment is supplied the desired 12.6 volts. In typical equipment utilizing a lead-acid battery, overcharging of the 3S NMC battery is a concern. In order to prevent overcharging, according to one embodiment a voltage circuit 90 may be configured to disconnect voltage flow from the charging system 30 after a threshold is reached (i.e. 12.6 volts). The disconnection of voltage flow from the charging system 30 is performed due to the fact that the typical lead-acid battery is charged to 14.4-15 volts and instead the maximum charge capacity of the 3S cell pack 70 is 12.6 volts. An NMC battery may have a very low self-discharge rate (e.g., an NMC battery may lose very little charge over time (i.e., 0.1 percent) when not in use, particularly as compared to lead-acid batteries, which may lose 1 percent of charge capacity a day when not in use). According to various embodiments, the 3S cell pack 70 may contain a number of cells in parallel. For example, the cell pack 70 may take the form of a 3S-1P, wherein one cell is wired is parallel, or 3S-2P, wherein two cells are wired is parallel, or 3S-3P, wherein three cells are wired is parallel, or 3S-4P, wherein three cells are wired is parallel, etc. The number of cells that are wired in parallel in the cell pack 70 directly correlate to the capacity of the cell pack 70. Accordingly, in a given application a 4S cell configuration may utilize any number of cells in parallel to suit the capacitance needs of that application and may take the form of, for example, a 4S-1P, a 4S-2P, a 4S-3P, a 4S-4P, etc.

In a 4S NMC cell pack 70, the 16.8 volt charge capacity is greater than 14.4-15 volt charge which is the typically generated for a lead acid battery. As such, according to one embodiment, the 4S NMC battery utilizes a voltage circuit 90 (e.g. a bucking circuit) to ensure that the electrical system of the equipment is supplied the desired 12.6 volts. In typical equipment utilizing a U1 battery, undercharging of the 4S NMC battery may be a concern. In order to prevent undercharging, according to one embodiment a voltage circuit 90 may be implemented to increase voltage flow from the charging system 30. The increase of voltage flow from the charging system 30 is necessary due to the fact that the typical lead-acid battery is charged to 14.4-15 volts and instead the maximum charge capacity of the 4S cell pack 70 is 16.8 volts. According to one embodiment, in order to prevent undercharging, a voltage circuit 90 may be implemented to increase the voltage supplied to the cell pack 70 from the typical 14.4 volts to 16.8 volts.

In yet another embodiment, an internal combustion engine includes a battery 50 using rechargeable LFP battery cells. The LFP battery provides significant power density. This facilitates starting an internal combustion engine in a variety of applications, such as outdoor power equipment, or other equipment which frequently have high thresholds for the power required for starting. The LFP battery may be used advantageously with outdoor power equipment that has beneficial charging requirements and schemes. In various embodiments, outdoor power equipment may have a charging system providing an optimized charging voltage potential below the overcharge threshold of the LFP battery, eliminating the need for complex battery management systems found in systems using lithium ion batteries. By way of example, in some embodiments, an LFP battery may include four cells with a 3.2 volt full cell potential, a 12.8 volt full pack potential, a 14.4 volt maximum full pack potential, and a 16 volt full pack overcharge threshold; the outdoor power equipment may have a charging system potential of 14 volts, such that the charging system can never overcharge the battery (i.e., the 14 volts supplied by the charging system is less than the 14.4 volt maximum full pack potential). Also, the difference between the 14 volt charging system potential and the 14.4 volt maximum full pack potential results in only a small amount of lost or un-used battery capacity (i.e., 0.4 volts). An LFP battery may have a very low self-discharge rate (e.g., an LFP battery may lose very little charge over time when not in use, particularly as compared to lead-acid batteries). An LFP battery may have a lifespan of several thousand cycles.

In various embodiments, the LFP battery is made of cells with a discharge threshold potential low enough such that when used in combination with outdoor power equipment, the outdoor power equipment may never draw enough current from the battery for the resulting voltage of the battery to be less than the discharge threshold potential of the battery. By way of example, in some embodiments, the LFP battery may include four cells with a 2.0 volt discharge threshold potential, and an 8.0 volt full pack discharge threshold potential. The outdoor power equipment may never draw enough current from the LFP battery for the resulting voltage of the LFP battery (or any cell therein) to be less than the discharge threshold potential. By way of example, an LFP battery may be tasked with delivering a startup pulse of 200 amps at 12.8 volts for 10 milliseconds, totaling 25.6 Joules of energy output. The 25.6 Joules energy output is fractional relative to the total energy capacity of the LFP battery (e.g., an LFP battery having a specific energy of 320-400 Joules/gram); therefore, each startup pulse does not significantly decrease the energy stored in the battery, and even numerous startup pulses will not cause the LFP battery to discharge (or the voltage of the battery following a startup pulse to be less than the discharge threshold potential). In various embodiments, the size of the LFP battery is configured such that the LFP battery may deliver startup pulses having various current and time profiles (e.g. currents greater than/less than 200 amps, times greater than/less than 10 milliseconds, etc.).

Battery systems associated with lawn and garden equipment (e.g., riding lawn mowers, tractors, etc.) may lack regulators that control one or more features (e.g., voltage, current, etc.) of the electrical power provided to one or more cells from, for example, an alternator 40 or charging system 30 of the engine. A lack of a regulator may adversely impact the one or more cells. By way of example, damaging current spikes and/or damaging voltage spikes may be provided to the one or more cells and adversely impact cell performance and/or cell life. In one embodiment, a battery is provided that isolates a primary cell pack from such current spikes and/or voltage spikes. A secondary cell pack may power auxiliary loads and be used to charge the primary cell pack, thereby isolating the primary cell pack from the current spikes and/or voltage spikes. A processing circuit may selectively couple the primary cell pack to a terminal of the battery and thereby supplement an electrical power output provided by the secondary cell pack (e.g., during engine starting, when the auxiliary loads exceed the input power provided to the secondary cell pack, when an auger or other relatively high-current-draw accessory is in use, etc.).

Battery systems associated with lawn and garden equipment may experience lengthy periods of inactivity during which the charge level of one or more cells thereof (e.g., lithium ion cells, etc.) may decrease. When producing a piece of equipment, a manufacturer often installs a battery having one or more cells into the equipment and thereafter ships the equipment to a wholesaler or distributor. The wholesaler or distributer may then stock the equipment until it is sold. Depending on customer demand, many weeks or months may elapse between when the battery is installed by the manufacturer and when the battery is utilized by a user (e.g., to start and/or power the newly purchased lawn and garden equipment, etc.). During the elapsed time, the charge level of the one or more cells may be reduced. In some instances, total replacement of the battery is required. Such circumstances occur particularly in the lawn and garden market where equipment purchases are relatively seasonal, where equipment may be stocked for prolonged periods of time. In one embodiment, a battery is provided that isolates a primary cell pack (e.g., including one or more cells, etc.) from one or more electrical loads associated with the lawn and garden equipment. Disconnecting the primary cell pack may reduce the risk of discharge during periods of inactivity (e.g., between the manufacture of the battery and use thereof, etc.).

Referring to FIGS. 3-4A, a schematic representation of a piece of equipment 1000 is illustrated according to an exemplary embodiment. The equipment 1000 includes an engine 10, a starter motor 20, a charging system 30, and a lithium-ion battery 50. The charging system 30 intermediates energy transfer between the engine 10, starting motor 20, and lithium-ion battery 50. The charging system includes an alternator 40 and may additionally include a regulator 80.

According to the exemplary embodiment shown in FIGS. 3-4A, the BMS 60 may include at least one of cell protection circuitry and charge control circuitry. The BMS 60 thus includes circuitry for managing the charge state and voltage applied to the lithium-ion battery 50, and particularly, manages the charge state and voltage applied to specific cells in the cell pack 70 of the lithium-ion battery 50. By way of example, the BMS 60 may be configured to charge the lithium-ion battery 50 according to a constant-current (CC) and/or a constant-voltage (CV) scheme. As illustrated in FIG. 3, a lithium-ion battery 50 may include the BMS 60 as an integral component of the battery itself. In other cases, battery management features, such as cell protection circuitry and charge control circuitry, may be provided remote from the lithium-ion battery 50.

The lithium-ion battery 50 includes one or more cells, shown as cell pack 70. In one embodiment, the cell pack 70 contains a plurality of lithium-ion cells that store energy from the alternator 40. In other embodiments, the cell pack 70 contains cells of other compositions. The cell pack 70 selectively transfers the energy to the starter motor 20 and other on-board electronics, according to an exemplary embodiment.

The BMS 60 includes a voltage circuit 90 is configured to alter the voltage coming into the lithium-ion battery 50 from the alternator 40 and/or the regulator 80. Depending on the cell pack 70 composition and configuration, the incoming voltage may need to be boosted (increased) or bucked (decreased). Typical charging systems 30 output approximately 14 volts. According to an exemplary embodiment, wherein the battery 50 utilizes a 4S NMC cell configuration, the voltage coming out of the charging system 30 must be increased (i.e. boosted) such that it is increased from 14 volts to approximately 16.8 volts. According to another exemplary embodiment, wherein the battery 50 utilizes a 3S NMC cell configuration, the voltage coming out of the charging system 30 must be decreased (i.e. bucked) such that it is decreased from 14 volts to approximately 12.6 volts. In conventional applications, the lead-acid battery does not require the voltage leaving the regulator or alternator to be bucked or boosted. However, in order to utilize 4S or 3S NMC lithium-ion battery 50 configurations the BMS 60 accounts for the difference in voltage from the cell pack 70 and the voltage coming from the charging system 30. The BMS 60 may operate with or without the presence of the regulator 80 in the charging system 30.

Referring to FIGS. 4B-4D, electrical circuit diagrams portions of the equipment 1000 are shown, according to various exemplary embodiments. In the circuit of FIG. 4B, the processing circuit 62 is activated, and in turn activates the voltage circuit 90, when a voltage of the cell pack 70 is below a threshold value. When the voltage of the cell pack 70 is above the threshold the processing circuit 62 as well as the voltage circuit 90 are deactivated. FIG. 4B illustrates a “boosting” circuit where the output of the charging system 30 is increased. FIG. 4C illustrates a “bucking” circuit where the output of the charging system 30 is decreased. FIG. 4D shows an exemplary embodiment where the battery 50 includes an inductor.

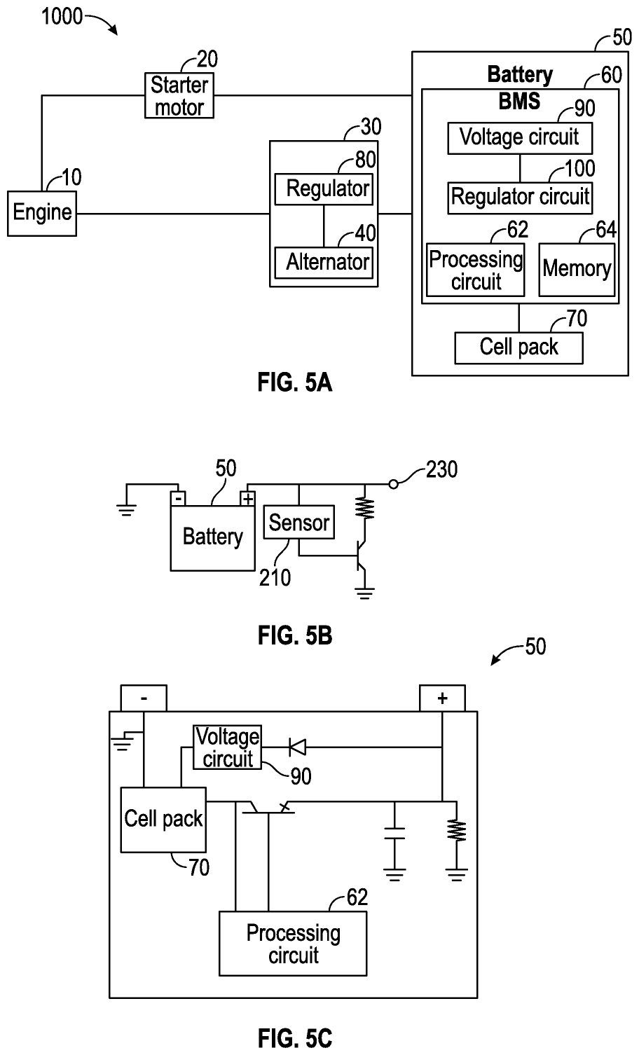

Referring to FIG. 5A, the equipment 1000 depicted in FIG. 3 is shown with the addition of a regulator circuit 100 within the BMS 60. In one embodiment, the regulator circuit 100 is configured to mitigate some of the issues associated with utilizing a battery 50 of a voltage differing from the standard lead-acid battery voltage of 12.6 volts. According to an exemplary embodiment, the equipment 1000 may utilize a 4S or 3S cell configuration wherein the battery 50 voltage differs from the standard lead-acid battery voltage. The 4S or 3S cell configuration may include any number of cells in parallel with the cells in series in the cell pack 70. In one embodiment, the battery 50 is configured to modify input and outputs from elements within the battery 50. The battery 50 is intended to replace a standard lead-acid battery with no additional set-up or configuration to be performed by the operator. Accordingly, the charging system 30 will continue to output the same voltage regardless of the voltage of the cell pack 70 within the battery 50. In order to preserve the integrity of the equipment 1000 it is necessary to throttle (i.e. start or stop) the flow of voltage from the charging system 30 to the battery 50. In application, the charging system 30 ceases to supply the battery 50 with voltage when the charging system 30 has determined that the desired voltage, 12.6 volts for a lead-acid battery, has been achieved.

In an exemplary embodiment, the BMS 60 includes a regulator circuit 100 configured to provide the charging system 30 with a compensation voltage. The compensation voltage manipulates the operating range of the regulator 80 in order to charge a battery with a charging voltage greater than or less than the charging voltage of a standard lead-acid battery. The regulator circuit 100 also includes a processing circuit, a memory, and an input-output interface. The compensation voltage may effectively translate the voltage scale the charging system 30 is configured for (e.g., the lead-acid 12.6 volt scale), to match the needs of the cell pack 70 configuration for a given battery 50. According to an exemplary embodiment, wherein the battery 50 utilizes a 4S NMC cell configuration, the compensation voltage will instruct the charging system 30 to continue to output voltage until the battery reaches 16.8 volts, a voltage which is much higher than the lead-acid voltage of between 14.4-15 volts. According to another exemplary embodiment, wherein the battery 50 utilizes a 3S NMC cell configuration, the compensation voltage will permit the charging system 30 to continue charging the battery 50 until the battery 50 reaches 12.6 volts, a voltage which is lower than the lead-acid voltage of between 14.4-15 volts. The compensation voltage may be constructed in a variety of manners including the use of scaling (i.e., logarithmic, exponential, factorial, etc.) and the use of or algorithmic manipulation.

Referring to FIGS. 5B-5C, electrical circuit diagrams for exemplary embodiments are shown. The system outlined in FIG. 5B allows for full battery current in and out of the battery 50. The system of FIG. 5B Is not limited by field-effect transistor (FET) ratings. The system of FIG. 5B does not require large and expensive FETs exceeding 300A. According to FIG. 5B, when the charging voltage exceeds a threshold, the circuit turns on a 20A FET and dissipates the energy. The FET is turned off when the charging voltage is returned to a level below the threshold. FIG. 5C illustrates an exemplary embodiment of a battery 50 including a voltage circuit 90, a cell pack 70, and a processing circuit 62.

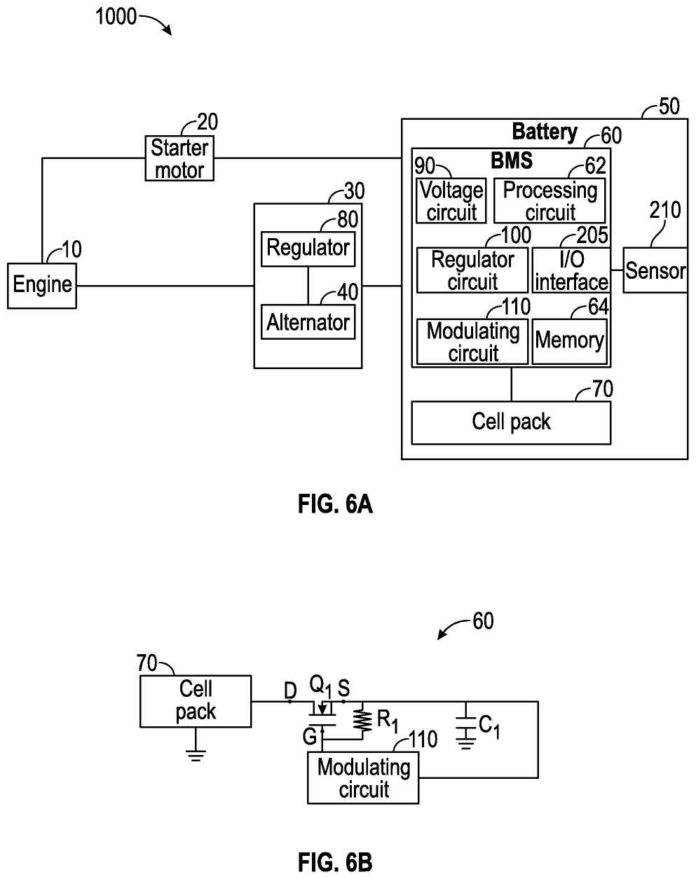

Referring to FIG. 6A-6B, the equipment 1000 depicted in FIG. 6A is shown with the addition of a modulator circuit 110 and a sensor 210 within the BMS 60. The modulator circuit 110 also includes a processing circuit, a memory, and an input-output interface. According to an exemplary embodiment, wherein the battery 50 utilizes a 4S NMC cell configuration, the 16.8 volt output from the battery 50 will be greater than desired for most equipment on-board electrical systems are designed to accept a 12.6 volt battery, such as the lead-acid battery. Accordingly, it is necessary to modulate the voltage output from the battery 50 is modulated by modulating circuit 110 such that an appropriate voltage power supply is created for the electrical system of the equipment during the various stages of use. In order to achieve this goal, the modulator circuit 110 periodically queries the sensor 210 for information about the battery 50 or the interaction with the charging system 30. In one embodiment, the sensor 210 is configured to provide sensor data relating to the temperature from within the battery 50, cell pack 70 temperature, ambient temperature if the sensor 50 was mounted on the exterior of the battery 50, incoming and/or outgoing current and/or voltage, impedance, vibratory displacement, and other electrical and thermodynamic properties. In another embodiment, the modulator circuit 110 may be configured to query the sensor 210 at a specified time increment. FIG. 6B illustrates an electrical circuit for an exemplary embodiment. In one embodiment, the modulating circuit 110 utilizes pulse-width modulation (PWM) schemes. According to one example, during start-up of the engine 10, a one-hundred per cent duty cycle (i.e. full load) may be supplied from the battery 50. In other situations (i.e., once the engine has started), the modulating circuit 110 may provide lower duty cycles in order to provide only the necessary voltage. In operation, the ambient temperature may affect the PWM scheme used. For example, in a cold weather operation (e.g., operating a riding lawn mower in early spring or late fall in North America) a higher duty cycle may be supplied than for a warm weather operation (e.g., operating a riding lawn mower in the middle of summer in North America) where a lower duty cycle would be utilized. The colder ambient temperature (i.e., zero degrees Celsius) provides the starter motor 20 additional cooling and therefore increases the tolerance of the starting motor 20 to higher loading. Conversely, in warmer ambient temperatures (i.e., twenty-five degrees Celsius) the starter motor 20 has a decreased tolerance to higher loading and therefore generally utilizes a lower duty cycle.

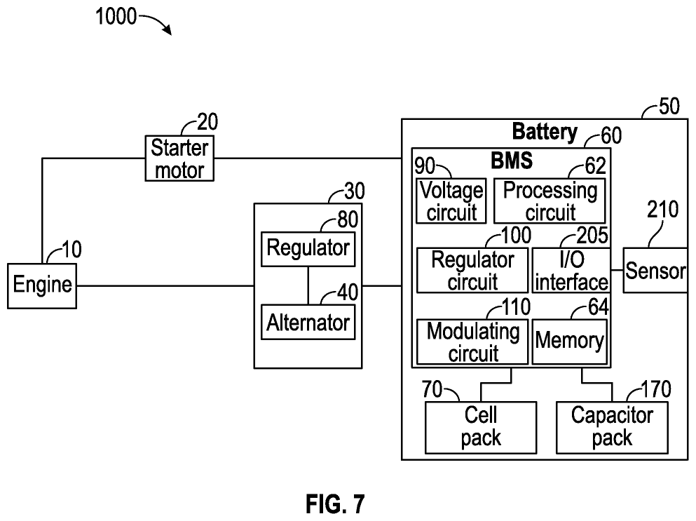

Referring to FIG. 7, the equipment 1000 depicted in FIG. 6 is shown with the addition of a capacitor pack 170. The capacitor pack 170 includes several capacitors interconnected and wired to the battery 50 and BMS 60. In alternative embodiments, the capacitor pack 170 could utilize super capacitors, battery cells, or another suitable electronic energy storage device (battery, capacitor, etc.). When cranking an engine 10, there is an increased load during the compression stoke. In certain applications, such as cold-weather application, the starter motor 20 may not be able to turn the engine 10 over and start the engine 10. According to an exemplary embodiment, the battery 50 includes a capacitor pack 170. The capacitor pack 170 is intended to supplement the cell pack 70 during times of extreme load on the cell pack 70 (i.e., starting the engine in cold-weather conditions). The low internal resistance of the capacitor pack 170 allows for the maximization of the stored energy. Through the use of PWM, the capacitor pack 170 can be utilized on a rapid basis. For example, during a compression stroke where the load on the cell pack 70 is high, the capacitor pack 170 may direct energy to the starter motor 20 to lessen the load on the cell pack 70. Conversely, during times of decreased load on the cell pack 70 the capacitor pack 170 may supply little to no energy to the battery 20 and instead may even be recharged by the battery 50. The capacitor pack 170 may also be used to supply the initial inrush current surge used to power the starter motor 20 to start the engine 10.

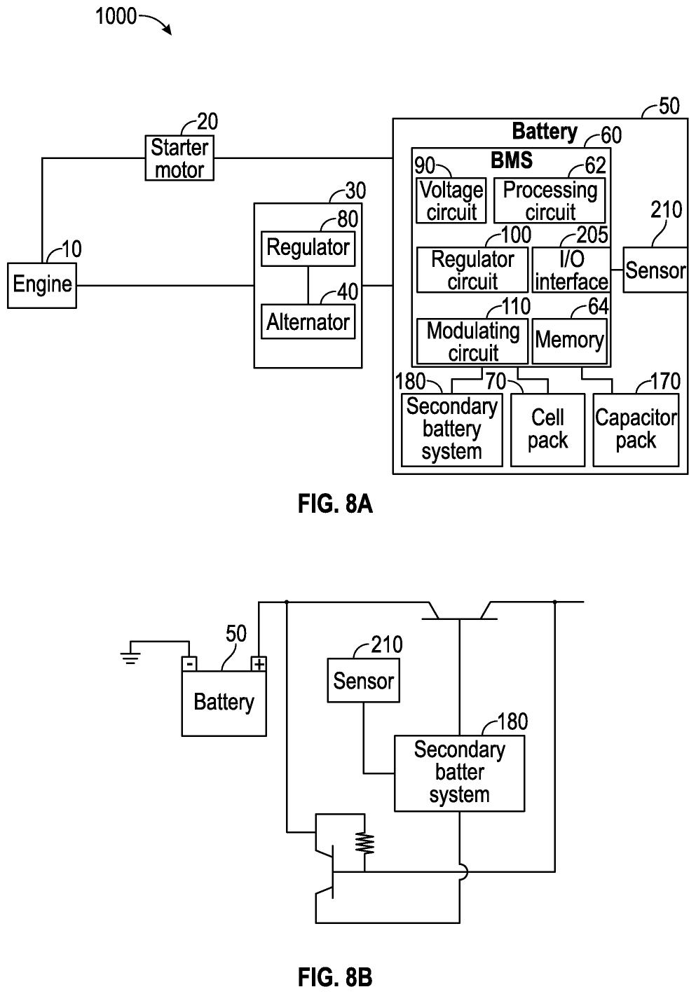

Referring to FIG. 8A, the equipment 1000 depicted in FIG. 7 is shown with the addition of a secondary battery system 180. A disadvantage of conventional lead-acid batteries is the quick charge depletion rates during non-use. While lithium-ion batteries provide a significant decrease in depletion rates during non-use (perhaps 0.1% per day) a gradual depletion of the battery 50 still exists. Accordingly, it is advantageous to completely disconnect the battery 50 from the system in between uses. According to some embodiments, the battery 50 further includes a secondary battery system 180. The secondary battery system 180 includes a reserve cell, a processing circuit, a memory, and an input-output interface. According to an exemplary embodiment, it is desirable to maintain a certain power level within the battery 50 between uses. For example, after prolonged storage the operator may wish to start the engine 10 using the battery 50 and without having to externally charge the battery 50. In typical applications, the operator is required to recharge the battery if a certain amount of the battery 50 charge has depleted.

According to an exemplary embodiment, a equipment 1000 with a secondary battery system 180 may maintain enough charge for the operator to start the engine 10 in at least one instance. For example, while in storage the charge of the battery 50 may gradually deplete. However, utilizing the secondary battery system 180, the battery 50 is disconnected once a certain threshold has been met, thereby isolating the battery 50 from further undesirable depletion. According to an exemplary embodiment, it may be desired for the battery 50 to store enough of a charge to start the engine 10 in at least three instances. The secondary battery system 180 may set this threshold according to a variety of variables including current draw, voltage draw, a predetermined time (i.e., a timer), a temperature variation, etc. According to an exemplary embodiment, the secondary battery system 180 sets the threshold according to a pre-programmed value. According to another exemplary embodiment, the secondary battery system 180 sets the threshold according to user inputted value (i.e., through a digital command, through a knob or selector switch, through a touch pad, through a key pad, through a potentiometer, etc.) According to yet another exemplary embodiment, the secondary battery system 180 sets the threshold according to a learned value. The learned value is set according to measurements taken during at least one previous engine 10 start up. For example, during an engine 10 start up, it may be determined that it requires 4.5 volts to start the engine 10. According to this example, the secondary battery system may record the 4.5 value and utilize it as the learned value in certain embodiments.

The reserve cell in the secondary battery system 180 is sized to power a processing circuit for a predetermined amount of time. According to an exemplary embodiment, the reserve cell in the secondary battery system 180 is sized to hold a charge for one year and to power critical on-board electronic systems. The reserve cell is not intended to power the equipment 1000 on startup and crank the engine 10. According to various embodiments, the reserve cell is intended to maintain power to small electronic devices such as internal processors, clocks, odometers, volatile memories, and other on-board electronics that are critical to the equipment 1000 would lose power and be shut off if the battery were to be disconnected. According to an exemplary embodiment, disconnecting the battery 50 places the battery 50 “power saving mode”.

According to some embodiments, the secondary battery system 180 is configured to disconnect the battery 50 when the equipment 1000 is not operating and after certain conditions have been met. By way of example, according to some embodiments, the secondary battery system 180 may be configured to disconnect the battery 50 after a certain amount of time has elapsed from the time the operator has powered down the engine 10. Alternatively, according to an exemplary embodiment without a secondary battery system, the processing circuit 62 contained within the BMS 60 may be configured to utilize a timer mechanism and automatically power down (i.e., shut down, turn off, disconnect, power off, etc.) the equipment 1000 after a predetermined amount of time had elapsed. According to this example, the processing circuit 62 may be configured to alter the predetermined amount of time based on inputs from a sensor 210 such as current and/or voltage draw from the battery 50, ambient temperature, engine temperature, battery temperature, etc. According to another embodiment, the secondary battery system 180 may be configured to disconnect the battery 50 when the outgoing or incoming current is below a certain threshold or remaining below a certain threshold for a period of time.

In yet another embodiment, the secondary battery system 180 may be configured to disconnect the battery 50 when the battery 50 temperature, ambient temperature, or engine 10 temperature is below a certain threshold. In yet another embodiment, the secondary battery system 180 may be configured to disconnect the battery 50 when the capacitance of the battery 50 is below a certain threshold. In yet another embodiment, the secondary battery system 180 may be configured to disconnect the battery 50 when the impedance of the battery 50 or the electrical system is below a certain threshold. In yet another embodiment, the secondary battery system 180 may be configured to disconnect the battery 50 when the battery 50 voltage is below a certain threshold. In one embodiment, the secondary battery system 180 is configured to reconnect the battery 50 upon receiving an input from the operator (e.g. the operator activates a key switch or pushes a start button to initiate the engine cranking sequence). Upon use, the charging system will charge the cell pack of the secondary battery system 180 as well as the capacitor pack 170 and the cell pack 70 of the battery 50. According to yet another embodiment, the secondary battery system 180 is intended to prevent the operator from unintentionally draining the battery 50. During operation, it is possible for an operator to forget to turn off electrical loads such as headlights on riding lawn mowers. This mistake will drain a battery 50 if not remedied. The secondary battery system 180 is intended to monitor conditions and loads on the battery 50 to determine if such events have taken place. In the event that an electric load exists after the system has been powered off (i.e. the lawn mower has been shut down), the secondary battery system 180 will not permit the battery 50 to deplete below a certain threshold. This threshold may be based on time, current, voltage, or other suitable parameters. While not in use, the battery 50 may deplete due to parasitic loads. Parasitic loads most noticeably effect equipment 1000 that has not been operated (i.e., the engine has not been cycled) is a prolonged period of time, such as during seasonal storage (e.g., storage of a lawn tractor for winter, storage of a snow-thrower for summer, etc.). According to one embodiment, the secondary battery system 180 may monitor for parasitic loads based on current and/or voltage and may be configured to disconnect the battery 50 after a certain threshold has been reached. For example, the secondary battery system may allow parasitic loads to deplete a predefined percentage of the cell pack 70 voltage before the secondary battery system 180 disconnects the battery 180. Disconnecting the battery 50 is achieved by completely isolating the battery 50 from the surrounding circuitry.

According to another exemplary embodiment, the reserve cell may be configured to be located at or near a battery terminal. According to this embodiment, following a decoupling of the battery 50 from the engine 10, the reserve cell absorbs undesirable charging pulses. According to another embodiment, the reserve cell provides power to equipment and/or engine electronics. According to yet another embodiment, the reserve cell can be configured to the voltage circuit 90 to provide additional amplification for the charging of the cell pack 70. According to yet another exemplary embodiment, the reserve cell can be configured to supply the regulator circuit 100 with the compensation voltage. According to yet another exemplary embodiment, the reserve cell can be configured to supplement power output. According to yet another exemplary embodiment, the charge of the cell pack 70 can be preserved while limited power (e.g., limited to a time interval, current limit, voltage limit, etc.) can be provided by the reserve cell. According to yet another exemplary embodiment, the reserve cell can be configured to provide filtering for the modulating circuit 110. This embodiment is further described in the appendix.

Referring to FIG. 8B, the electrical system showing the interaction between the battery 50, the sensor 210, and the secondary battery system 180 is shown. The sensor 210 and secondary battery system 180 are contained within the battery 50. The starter motor 20 connection is a ground signal. According to an exemplary embodiment, the secondary battery system 180 determines if the operator is starting the equipment 1000. The sensor 210 can be configured to monitor one or more variables including measurements on temperature from within the battery 50, cell pack 70 temperature, ambient temperature if the sensor 50 was mounted on the exterior of the battery 50, incoming and/or outgoing current and/or voltage, impedance, vibratory displacement (i.e., measured through an accelerometer), and other electrical and thermodynamic properties.

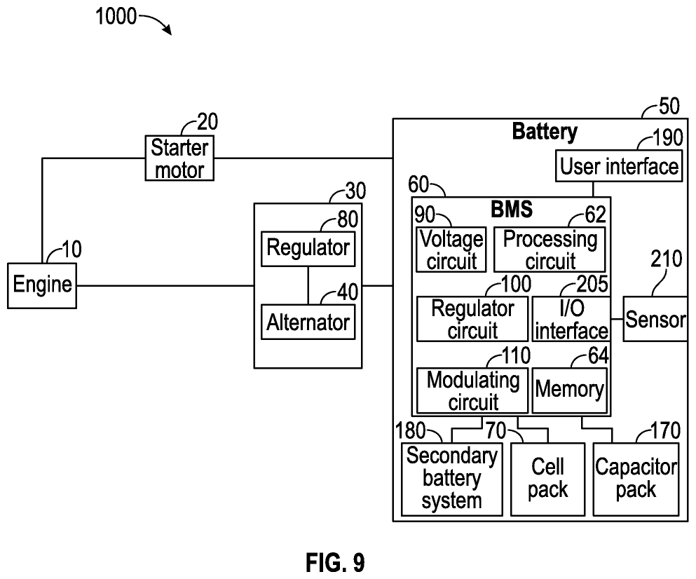

Referring to FIG. 9, the equipment 1000 includes a user interface 190. According to an exemplary embodiment, the operator may not wish to completely disconnect the battery 50 for a variety of reasons. By way of example, small electronic devices such as internal processors, clocks, odometers, volatile memories, and other on-board electronics that are critical to the equipment 1000 would lose power and be shut off if the battery were to be disconnected. In order to prevent undesired disconnection, the operator may interact with the user interface 190 in order to disable power saving mode. In one embodiment, the user interface 190 includes a switch disposed on the outside of the battery 50. When not in power saving mode, the secondary battery system 180 is not permitted to disconnect the battery. If an operator ever wishes to turn on power saving mode, toggling the switch back to power saving mode is necessary. The switch may include a rocker switch, a push button switch, a rotary switch, a slide switch, a toggle switch, and other suitable switches.

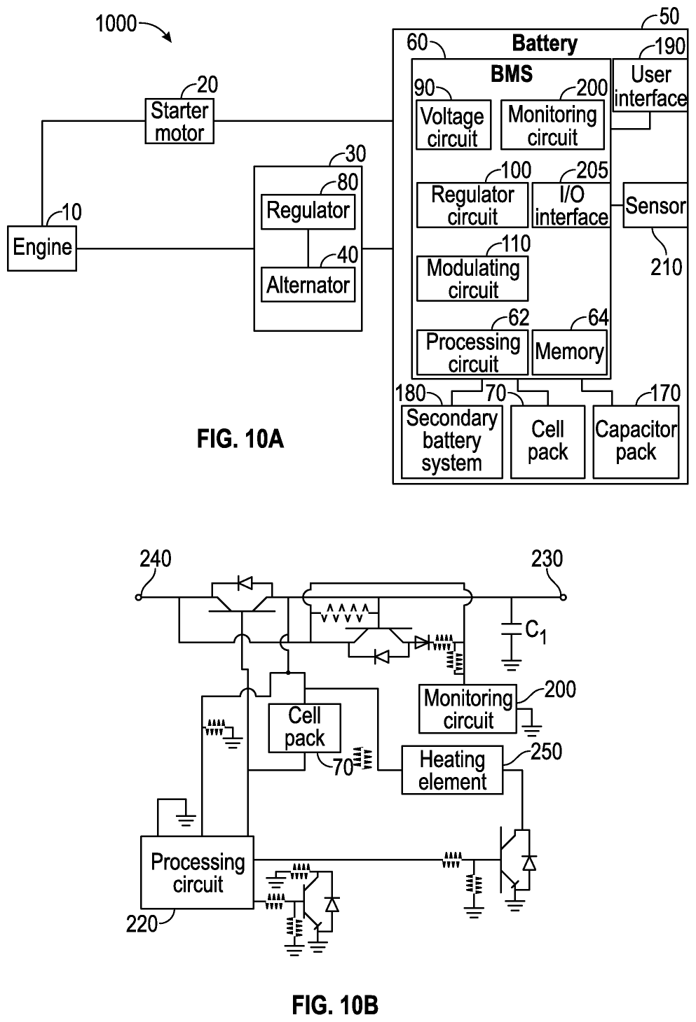

Referring to FIG. 10A, the equipment 1000 depicted in FIG. 9 is shown with the addition of a monitoring circuit 200 within the BMS 60. According to an exemplary embodiment, the equipment 1000 may include a mechanism for preventing the undesired over-cranking of the starter motor 20. Over-cranking of a starter motor 20 causes excessive heat buildup on the starter motor and is likely to result in failure of the starter motor 20 or other electrical components. According to an exemplary embodiment, the monitoring circuit 200 receives information from the sensor 210 about the current operating conditions of the system. In one embodiment, the sensor 210 is configured to provide sensor data relating to temperature from within the battery 50, cell pack 70 temperature, ambient temperature if the sensor 50 was mounted on the exterior of the battery 50, incoming and/or outgoing current and/or voltage, impedance, vibratory displacement, and other electrical and thermodynamic properties. When the equipment 1000 is activated, the monitoring circuit 200 queries the sensor 210 and makes a determination if an over-cranking event is occurring. The over-cranking event may be defined by a certain current, voltage, time, temperature, impedance, or capacitance threshold and may be recalculated based on ambient conditions. By way of example, the over-cranking event threshold will be higher in cold ambient temperatures where starter motor 20 failure is less likely to occur. Conversely, the over-cranking event threshold will be lower in high ambient temperatures where starter motor 20 failure is more likely to occur. Similarly, the over-cranking event threshold may be affected by engine 10 or starter motor 20 temperature. By way of example, repeated attempt to crank the engine 10 will raise the temperature of the starter motor 20 resulting in an increased likelihood of starter motor 20 failure. According to an exemplary embodiment, an operator may crank the engine 10 at 200 Amperes for 10 seconds, during which the monitoring circuit 200 ensures that an over-cranking event threshold has not been met. According to another exemplary embodiment, an operator may crank the engine 10 at 250 Amperes for 7 seconds before the monitoring circuit 200 de-energizes (i.e., disconnects) the battery 50 due to an over-cranking event threshold.

Referring to FIG. 10B, an electrical circuit for an exemplary embodiment, is shown. The electric circuit further includes a heating element for warming the cell pack 70 prior to cold starting of the engine 10. According to an exemplary embodiment, the processing circuit 220 includes a plurality of analogue to digital (A/D) convertors as well as a plurality of general purpose input-outputs (GPIO). According to FIG. 10B, when the analogue to digital conversion senses a large current draw, the temperature of the cell pack 70 is checked. If the cell pack 70 temperature is cold, the cell pack 70 is heated by the heating element 230. FIG. 10B also includes other mechanisms of the design related to the engine wake up and crank time limits. When waking up the engine, the capacitors should be powered first, and then the rest of the system. In regards to the limiting over cranking, FIG. 10B states that when current is high, over 200 A according to an exemplary embodiment, the cell pack 70 is shut off.

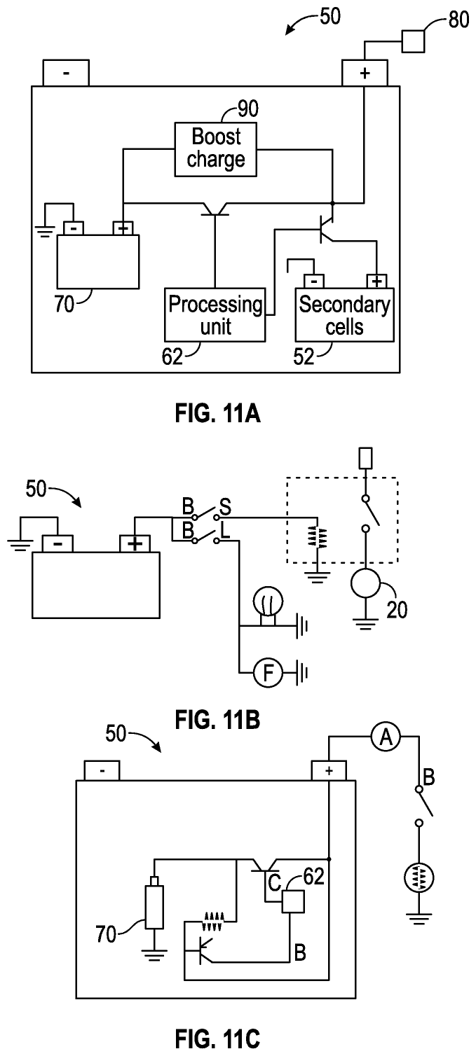

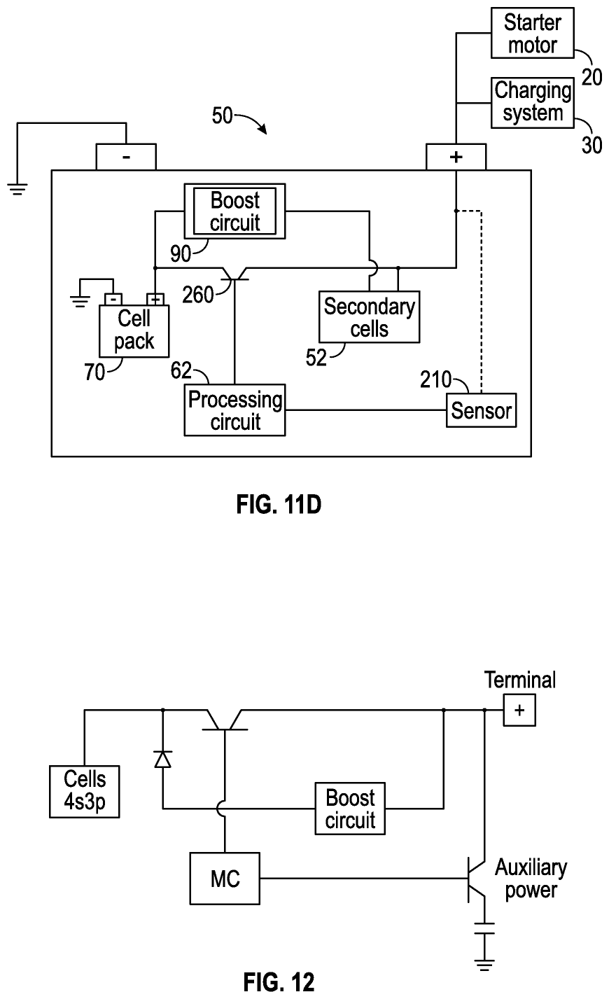

According to the alternative embodiment shown in FIG. 11A, the battery 50 includes an additional power source, shown as secondary cells 52. Secondary cells 52 may include a battery a capacitor, and/or another energy storage device. In one embodiment, the secondary cells 52 provide a current output to power various auxiliary components of a tractor. The cell pack 70 may thereby be reserved for high current starting. The secondary cells 52 and the cell pack 70 may be coupled to form one power source (e.g., to provide an increased discharge voltage and/or capacity, etc.). Such coupling may be selectively achieved, facilitating an operator's desire to selectively couple the secondary cells 52 and the cell pack 70 and/or selectively coupling secondary cells 52 and cell pack 70 according to a predetermined control scheme. The secondary cells 52 may be kept at the voltage of regulator 80 (e.g., charged by the regulator 80 and thereby held at the voltage provided by the regulator 80, etc.). The cell pack 70 may be at a voltage that is greater than the voltage that the regulator 80 may allow (e.g., at a voltage above which the regulator 80 operates, etc.). The voltage circuit 90 may boost the voltage of the current provided by the regulator 80 to that of the cell pack 70. The voltage relayed to the regulator 80 (e.g., and thereby used by the regulator to control the operation thereof, etc.) may be that of the secondary cells 52. The secondary cells 52 may thereby act as a load for the regulator 80. The secondary cells 52 present the charging system 30 and the regulator 80 with the expected load of a lead-acid battery so that the charging system 30 provides the charging current when it may not have otherwise done so.

According to an exemplary embodiment, the BMS 60 is configured to determine whether an ignition switch (e.g., a key switch, etc.) is engaged or disengaged (e.g., whether the ignition switch is turned on or turned off, etc.). The BMS 60 may be configured to respond in various ways based upon whether the ignition switch is engaged (e.g., decouple the engine from a load and/or the charging system 30, start a timer after which the engine is decoupled from a load and/or the charging system 30, etc.). By way of example, the battery 50 may include one or more sensors positioned to monitor an operating condition of the battery 50 and/or a circuit with which the battery 50 is associated and provide sensor data relating thereto. In one embodiment, the BMS 60 is configured to determine that the ignition switch is disengaged in response to an indication from the sensor that current is no longer flowing into the battery 50 (e.g., indicating that the engine 10 is no longer spinning, etc.). In another embodiment, the BMS 60 is configured to determine that the ignition switch is disengaged in response to an indication from the sensor that battery 50 is not experiencing a current draw (e.g., from lights, a fuel solenoid, an ECU, etc.). In still another embodiment, the BMS 60 is configured to determine that the ignition switch is disengaged in response to an indication from the sensor that the battery 50 and/or the equipment with which the battery 50 is associated is not vibrating or otherwise moving (e.g., the sensor may include an accelerometer, etc.). In one embodiment, the BMS 60 is configured to determine that the ignition switch is engaged in response to an indication from the sensor that a current flow is being provided by the battery 50 (e.g., to the starter motor 20, to lights, to a fuel solenoid, etc.). In another embodiment, the BMS 60 is configured to determine that the ignition switch is engaged in response to an indication from the sensor that a resistance along a circuit with which battery 50 is associated has decreased and/or that a connection to ground has occurred.

As shown in FIG. 11B, a tractor wiring scheme shows a battery (e.g., battery 50, etc.) selectively coupled to a starter solenoid and to lights and a fuel solenoid with a key switch (e.g., ignition switch, etc.). When the key switch is in an “off” position, no connection between B, S, and L occurs. When the key switch is brought into a “run” position, B is coupled with L, and current flows to the lights and the fuel solenoid, among other electrical components of the tractor. These resistive loads may be perceived by the circuit as ground connections. When the key switch is brought into a “start” position, B is coupled with L and B is coupled with S, and current flows to the lights, the fuel solenoid, and to the starter solenoid. Energizing the starter solenoid provides a current flow from battery 50 to starter motor 20 to start the engine (e.g., engine 10, etc.). In one embodiment, such a perceived ground connection is used by an “auto shutdown circuit” of battery 50 (e.g., regulator circuit 100, modulating circuit 110, processing circuit 62, etc.). By way of example, the circuit of battery 50 may “wake up” (e.g., recouple cells 70 with a terminal of battery 50, etc.) in response to the sensed perceived ground connection.

As shown in FIG. 11C, battery 50 may selectively power resistive loads (e.g., lights, a fuel solenoid, etc.) when the key switch is brought into the “run” or “start” positions, thereby coupling B and L. Discharge field-effect transistor (“FET”) at C may be initially disengaged such that cell pack 70 is disconnected from the key switch (e.g., disconnected from A). When the key switch is closed, B is coupled to L, and the resistive loads are coupled to A. Such coupling may energize the sense FET, conveying a command to the processing circuit 62 at B that a load has been sensed. In one embodiment, the processing circuit 62 is configured to engage the discharge FET at C, thereby connecting the cell pack 70 to the resistive loads through the closed key switch. The battery 50 may thereby wake up from a “sleep” condition whereby cell pack 70 is decoupled from the battery terminal and thereafter provide a current output (e.g., to the resistive loads, etc.).

As shown in FIG. 11D, a battery 50 includes a voltage circuit 90 that serves as a boost circuit, a processing circuit 62, a cell pack 70, secondary cells 52, and sensor 210. Battery 50 is electrically coupled to a charging system 30 and a starter motor 20, according to an exemplary embodiment. In one embodiment, cell pack 70 has a voltage that is greater than an electrical operating voltage of the lawn and garden equipment. For example, the cell pack 70 may be made of NMC lithium-ion battery cells arranged in a 4S configuration with a fully charged 16.8 volt full pack potential, which is greater than the 12 volt nominal electrical operating voltage of the lawn and garden equipment. Secondary cells 52 may have a voltage that may be close to the desired electrical operating voltage of the lawn and garden equipment. For example, the cell pack 70 may be made of LFP cells arranged in a 4S configuration with a 14.4 volt full pack potential which is close to the 12 volt desired electrical operating voltage of the lawn and garden equipment. According to the embodiment of FIG. 11D, the charging system 30 directly reads the voltage of the secondary cells 52. The secondary cells 52 may be charged by the charging system 30, and the cell pack 70 may be charged by the secondary cells 52. According to one embodiment, the cell pack 70 includes a plurality of lithium-ion cells, which may be of NMC, LFP, LCO, or other suitable chemistry. In embodiments where the cell pack 70 contains cells with an oxide chemistry (e.g. LCO, NMC, etc.), the cell pack 70 may be in a 4S configuration and may contain one, two, three, or more cells in parallel (e.g. 4S-2P, 4S-3P, etc.). In embodiments where the cell pack 70 contains cells with a phosphate chemistry (e.g. LFP, etc.), the cell pack 70 may be configured in the 5S configuration and may contain one, two, three, or more cells in parallel (e.g. 5S-2P, 5S-3P, etc.). The secondary cells 52 may include a plurality of lithium-ion cells, which may be of NMC, LFP, LCO, or other suitable chemistry (e.g., FeO₂ cell batteries, etc.). In other embodiments, the secondary cells 52 may include lead-acid cells, super capacitors, capacitors, or other suitable energy storage devices. In embodiments where the secondary cells 52 have a phosphate chemistry, a 4S configuration may be used and may contain one, two, three, or more cells in parallel (e.g. 4S-1P, 4S-2P, 4S-3P, etc.). In embodiments where the secondary cells 52 are comprised of an oxide chemistry, a 4S configuration may be used and may contain one, two, three, or more cells in parallel (e.g. 4S-2P, 4S-3P, 4S-4P, etc.). For example, the secondary cells 52 may be arranged in a 4S-2P configuration (i.e., a total of 8 cells).

Batteries may be characterized by their charge level (e.g., capacity, how much longer the battery can operate, etc.) and their voltage (e.g., at what voltage the battery provides output, etc.). It may be desirable to keep the charge level of the battery at 50%-90% of its target level (e.g., design charge level, maximum charge level, etc.). Lithium-ion batteries have particular properties (e.g., a particular relationship between their voltage and charge level, etc.). A lithium-ion battery 50 may have a voltage that increases as the charge level increases. While lithium-ion batteries may attain a higher voltage level in a shorter amount of time, the charge level of the lithium-ion batteries may increase at a relatively lower rate. Lithium-ion batteries may need to be charged for a long enough time to insure that a proper charge level has been obtained.

The voltage circuit 90 that serves as a boost circuit is configured to facilitate charging the cell pack 70 from the secondary cells 52 (e.g., continuously, selectively, etc.). According to various embodiments, the cell pack 70 is configured to have a larger charging voltage than the nominal voltage of the secondary cells 52. The voltage circuit 90 that serves as a boost circuit may increase the voltage from the secondary cells 52 to that of the cell pack 70. By way of example, the cell pack 70 may have a charging voltage of 16.8 volts and the secondary cells may have a nominal voltage of 14.4 volts so the boost circuit is used to increase the 14.4 volt output from the secondary cells 52 to the 16.8 volt charging voltage of the cell pack 70.

In one embodiment, the sensor 210 is positioned to monitor an operating condition associated with the battery 50 and provide sensor data relating thereto. The sensor 210 may be used to determine that an operator is attempting to start the engine (e.g., thereby indicating a starting condition, etc.). During a loading condition, such as starting of the engine, operating auxiliary loads, and placing of other electrical loads on the equipment 1000, the battery 50 experiences a current draw directly related to the loading condition (and a corresponding voltage drop depending on the load). According to an exemplary embodiment, the sensor 210 is configured to monitor the current draw from the battery 50 and provide sensor data relating thereto to the processing circuit 62. The processing circuit 62 may compare the current draw with that of a threshold range (e.g., a threshold value, etc.). According to another exemplary embodiment, the sensor 210 is configured to monitor the voltage provided by the secondary cells 52 and/or battery 50. The processing circuit 62 may utilize the sensor data from the sensor 210 and compare the voltage provided by the secondary cells 52 and/or the battery 50 with a threshold range. According to another exemplary embodiment, the sensor 210 may be configured to monitor the current draw from the battery 50 and the voltage provided by the secondary cells 52 and/or the battery 50. The processing circuit 62 may evaluate the current draw and voltage signals and compare them with one or more threshold ranges. According to another exemplary embodiment, the processing circuit 62 may include a timer (e.g., a timer that indicates an elapsed time, a timer hat counts down from a preset, etc.). According to some embodiments, the thresholds may be replaced with other mathematical comparison methods such as range fluctuation, statistical methods, and other numerical analysis methods that may be performed on the inputs from the sensor 210.

The processing circuit 62 may identify an excess loading condition in response to a condition monitored by the sensor 210 at least one of exceeding or falling below a threshold range (e.g., the voltage provided by secondary cells 52 falls from 14 volts to 10 volts, the voltage provided by the secondary cells 52 and/or the battery 50 falling below the threshold range, the voltage provided by the secondary cells 52 and/or the battery 50 falling at a rate that exceeds the threshold range, the timer indicating an elapsed time that exceeds the threshold range, etc.). The processing circuit 62 may selectively couple the cell pack 70 with the terminal of the battery 50 in response to identifying the excess loading condition (e.g., and thereby supplement the output provided by the secondary cells 52, etc.). According to the embodiment shown in FIG. 11D, the processing circuit 62 is configured to engage a switch 260 to selectively couple the cell pack 70 with the terminal of the battery 50 (e.g., and thereby supplement the output provided by the secondary cells 52, etc.). Supplementing the current provided by the secondary cells 52 (e.g., with the cell pack 70, etc.) may be particularly important when starting the engine as the starter may draw more current than the secondary cells 52 provide. According to an exemplary embodiment, the switch 260 is a MOSFET. In other embodiments, various other types of switches are provided (e.g., hall-effect switches, magnetic switches, electrical switches, etc.). In other embodiments, the processing circuit 62 selectively couples the cell pack 70 to the terminal using a mathematical assessment of one or more signals (e.g., a weighted combination, etc.).

The cell pack 70 provides additional electrical output power to meet elevated electrical demands required of the battery 50 during loading conditions. The processing circuit 62 may continue to monitor the operating condition associated with the battery 50 (e.g., using sensor data provided by sensor 210, etc.) after engaging the switch 260. The processing circuit 62 may selectively decouple the cell pack 70 from the terminal of the battery 50 in response to a determination that the loading condition has ended and/or will be ended (e.g., the voltage provided by secondary cells 52 increasing to 14 volts, the voltage provided by the secondary cells 52 and/or the battery 50 exceeding the threshold range, the voltage provided by the secondary cells 52 and/or the battery 50 increasing at a rate that exceeds the threshold range, etc.). The secondary cells 52 alone may thereafter provide the power output from the battery 50. In other embodiments, the processing circuit 62 may be configured to disconnect the cell pack 70 from the battery 50 through the switch 260 after a predetermined amount of time.

During operation of the lawn and garden equipment with which the battery 50 is associated, utilizing one or more attachments and/or auxiliary loads (e.g., lights, radio, etc.) may also contribute to and/or independently induce a loading condition. By way of example, the operator may operate an auger attachment on a riding lawn mower. The cell pack 70 may contribute to powering the auger attachment (e.g., the processing circuit 62 may engage the switch 260, etc.) in response to the voltage applied by the secondary cells 52 falling below a threshold level. In other embodiments, the cell pack 70 powers the attachment (e.g., the processing circuit 62 may engage the switch 260, etc.) in response to a signal provided by a switch (e.g., positioned to indicate that the attachment is deployed on or with the lawn and garden equipment, with which a user interacts to engage the attachment, etc.). According to an exemplary embodiment, the processing circuit 62 monitors the electrical system through the sensor 210, the operator initiates the starting load (e.g., turns the key, turns on the engine, etc.) by electrifying the starter motor 20, and in response, the sensor 210 signals the processing circuit 62 to close the switch 260 thereby coupling the cell pack 70 to the terminal. According to this exemplary embodiment, upon termination of the starting load, the sensor 210 signals the processing circuit 62 to open the switch 260 thereby decoupling the cell pack 70 from the terminal after which only the secondary cells 52 will provide electrical power to the system 100.

In one embodiment, the processing circuit 62 is configured to prevent the battery 50 from providing more than a prescribed voltage limit (e.g., 13.5 volts, 14 volts, 14.4 volts, etc.). By way of example, the processing circuit 62 may prevent the battery 50 from providing more than the prescribed voltage limit at all times, including when starting. In another embodiment, the processing circuit 62 is configured to facilitate battery 50 providing a voltage greater than the prescribed voltage limit. By way of example, the processing circuit 62 may be configured to directly couple the cell pack 70 to the terminal of the battery 50. By way of another example, the processing circuit 62 may employ PWM and provide a voltage from the cell pack 70 that matches the prescribed voltage limit. A voltage above the prescribed voltage limit may facilitate starting the engine in cold operating conditions. The prescribed voltage limit may protect the electrical system of the lawn and garden equipment with which the battery 50 is associated. According to an exemplary embodiment, a voltage limit of between 13.5-14 volts is imposed by the processing circuit 62 on the battery 50. The voltage limit is sized to prohibit the electrical system from experiencing a voltage to its components that is greater than the maximum voltage the components were intended to operate with. Operating a component at a voltage greater than the recommended maximum voltage of that component may lead to failure and/or damage to that component. Therefore, by enforcing a voltage limit on the electrical system, all components can be protected from failure and/or damage.

The secondary cells 52 of the battery 50 are configured to be charged by the charging system 30 of the equipment. The charging system 30 may read an operating condition of the secondary cells 52 (e.g., voltage, current output, etc.). The secondary cells 52 charge the cell pack 70 through the voltage circuit 90 that serves as a boost circuit. In some embodiments, the charging system 30 does not include a regulator 80. In such embodiments, the secondary cells 52 protect the cell pack 70 against voltage spikes and/or current spikes provided by the charging system 30. Such voltage spikes and/or current spikes may otherwise damage the cell pack 70. In one alternative embodiment, damaged secondary cells 52 may be replaced by the operator without replacing the cell pack 70. According to another exemplary embodiment, the charging system is configured to accept an input of 14.4 volts and/or operate at 14.4 volts, and the secondary cells 52 of the battery 50 are configured to accept 14.4 volts and/or operate at 14.4 volts.

In one embodiment, the secondary cells 52 continuously charge the cell pack 70. In other embodiments, the secondary cells 52 charge the cell pack 70 at various predetermined time intervals. According to one embodiment, the processing circuit 62 is configured to selectively couple the secondary cells 52 to the cell pack 70 during non-loading conditions (e.g., the equipment has been started or is not running, etc.). According to another embodiment, the processing circuit 62 is configured to selectively couple the secondary cells 52 to the cell pack 70 only during non-operative conditions (e.g., the equipment is not running, etc.) and/or during operative and non-loading conditions (e.g., the equipment is running, etc.). The processing circuit 62 may be configured to facilitate the charging of the cell pack 70 from the secondary cells 52, operate the voltage circuit 90 in order to match the voltage provided to the cell pack 70 with the operational voltage thereof, determine whether a loading condition is occurring, disconnect the cell pack 70 during non-loading conditions, and connect the cell pack 70 during loading conditions, or any combination thereof.

Referring to FIG. 12, according to an exemplary embodiment the reserve cell could be utilized to provide power when the discharged FET is turned off (e.g., de-energized, toggled, etc.). According to this embodiment, the BMS 60 is configured to monitor the voltage or current of the reserve cell. According to this embodiment, it may be determined if the load has been applied and if the discharged FET needs to be turned on (e.g., energized, toggled, etc.).

One embodiment of the invention relates to a battery for equipment having a charging system including an engine regulator configured to provide a power output. The battery includes a cell pack having a rated charging voltage and a battery management system. The battery management system is coupled to the cell pack and configured to receive the power output from the charging system. The battery management system includes a regulator circuit configured to provide a compensation voltage to the engine regulator, wherein the compensation voltage varies based on the rated charging voltage of the cell pack. The engine regulator is configured to charge the battery in response to the compensation voltage falling below a target voltage and stop charging the battery in response to the compensation voltage exceeding the target voltage. In some arrangements, the regulator circuit is configured to vary the compensation voltage based on an output voltage of the battery. In other arrangements, the regulator circuit is configured to vary the compensation voltage in response to the voltage of the battery exceeding a threshold voltage. In further arrangements, the battery includes a sensor configured to monitor a voltage of the cell pack, wherein the regulator circuit is configured to vary the compensation voltage based on the voltage of the cell pack and in some cases, the regulator circuit is configured to vary the compensation voltage in response to the voltage of the cell pack exceeding a threshold voltage. In some variations, the regulator circuit is configured to scale the compensation voltage based on the rated charging voltage of the cell pack. In other variations, the compensation voltage is greater than a voltage of the battery. In some arrangements, the battery is in the shape of a U1 form factor.

Another embodiment of the invention relates to a battery for providing an output power to an equipment load. The battery includes a cell pack, a sensor positioned to monitor an operating condition of the battery and configured to provide sensor data related thereto, and a battery management system coupled to the cell pack and the sensor. The battery management system includes a modulating circuit configured to change a duty cycle of the output power based upon the sensor data provided by the sensor. In some variations, the sensor is configured to monitor at least one of an operating temperature of the cell pack, a voltage associated with the output power, a voltage at a terminal of the battery, a current associated with the output power, and a current at the terminal of the battery. In some variations, the modulating circuit is configured to increase the duty cycle of the output power in response to a determination that the operating temperature of the cell pack is below a threshold value. In another variation, the modulating circuit is configured to increase the duty cycle of the output power in response to a decrease in the voltage associated with the output power is below a threshold value. In another variation, the modulating circuit is configured to increase the duty cycle of the output power in response to a decrease in the voltage at the terminal of the battery is below a threshold value. In another variation, the modulating circuit is configured to increase the duty cycle of the output power in response to a decrease in the current associated with the output power is below a threshold value. In yet another variation, the modulating circuit is configured to increase the duty cycle of the output power in response to a decrease in the current at the terminal of the battery is below a threshold value. In some arrangements, the modulating circuit is configured to increase the duty cycle in response to a determination that the decrease has occurred for a threshold period of time.

Another embodiment of the invention relates to a battery for equipment having a charging system configured to provide a power output. The battery includes a cell pack, a capacitor pack including one or more capacitors coupled to the cell pack, and a battery management system coupled to the cell pack and the capacitor pack. The battery management system is configured to selectively charge the cell pack using the power output from the charging system, selectively store energy within the capacitor pack using the power output from the charging system, and selectively supplement a current output of the cell pack using the stored energy of the capacitor pack thereby increasing a cranking current of the battery. In some arrangements, the battery further includes a sensor coupled to the battery management system, wherein the sensor is positioned to monitor an operating condition of the battery and configured to provide sensor data related thereto. In some arrangements, the battery management system is configured to selectively charge the cell pack using the stored energy of the capacitor pack based on the sensor data. In some arrangements, the sensor is configured to monitor at least one of a current and a voltage of the power output provided by the charging system. In some arrangements, the battery management system is configured to selectively charge the cell pack in response to at least one of the current and the voltage of the power output provided by the charging system falling below a threshold value.

Another embodiment of the invention relates to a battery for equipment having a charging system and at least one electrical load. The battery includes a cell pack, a terminal coupled to the cell pack and configured to be coupled to at least one of the charging system and the at least one electrical load, a battery management system including a processing circuit configured to maintain a charge level of the cell pack by selectively decoupling the cell pack from the terminal. In some arrangements, the battery management system includes a timer module configured to monitor a time duration and a set point and provide a termination signal when the duration exceeds the set point, wherein the battery management system is configured to selectively decouple the cell pack from the terminal in response to receiving the termination signal from the timer module. In some arrangements, the battery further includes a sensor coupled to the battery management system, wherein the sensor is positioned to monitor an operating condition of the battery and configured to provide sensor data related thereto. In some arrangements, the sensor is configured to monitor at least one of a voltage and a current associated with a power output provided by the charging system, wherein the timer module is configured to begin counting down in response to the at least one of the voltage and the current falling below a threshold value. In other arrangements, the battery further includes a sensor coupled to the battery management system, wherein the sensor is positioned to monitor an operating condition of the battery and configured to provide sensor data related thereto. In some arrangements, the sensor is configured to monitor at least one of a voltage and a current associated with a power output provided by the charging system, wherein the battery management system is configured to decouple the cell pack from the terminal in response to the at least one of the voltage and the current falling below a threshold value. In other arrangements, the battery further includes a user interface coupled to the battery management system and configured to receive a user input, wherein the battery management system is configured to selectively maintain engagement between the cell pack and the terminal in response to the user input. In some arrangements, the user interface includes a switch coupled to a housing within which the cell pack is disposed.

Another embodiment of the invention relates to a battery for equipment having a starter. The battery includes a cell pack, a terminal coupled to the cell pack and configured to be coupled to the starter, and a battery management system including a processing circuit configured to reduce stress on the cell pack by selectively decoupling the cell pack from the terminal in response to an extended cranking event. In some arrangements, the battery further includes a sensor coupled to the battery management system, wherein the sensor is positioned to monitor an operating condition of the battery and configured to provide sensor data related thereto. In some arrangements, the sensor is configured to monitor a temperature of the cell pack, wherein the battery management system is configured to decouple the cell pack from the terminal in response to the temperature of the cell pack exceeding a threshold value.

In one embodiment, a power save feature is included. The power save feature monitors the current coming into and going out of the cell pack. After a predetermined time without any current coming in and charging the cells (i.e., the engine is not running) and a predetermined amount of low or no current draw going out of the cell pack, the microcontroller is allowed to turn off the cell pack. In some arrangements, the microcontroller can go into a low power state causing the silicon-controlled rectifier (SCR) to unlatch and cut off power to the regulator. In some arrangements, extra current circuitry is always on while the cell pack is on by turning on a micro pin that will cause an extra-low milliamp draw. By turning off the micro pin, the SCR will unlatch and turn off the system due to the drop in current draw going through the SCR.

In some embodiments, a wake up feature is included. After shutdown/power-saving mode, to wake up the cell pack, extra circuitry is included to allow any type of external load to be sensed. The extra circuitry causes the SCR to power up and latch.

In some embodiments, a crank time limiter is included. The crank time limiter monitors the outgoing current and when the current is high (over 20 amps) for a predetermine amount of time, the crank time limiter turns off the pack power MOSFETs.

In some embodiments, the voltage output is modulated. Using a micro A/D pin, the cell pack output voltage is monitored. The micro pack power MOSFET pin employs PWM to keep the cell pack voltage at or below a specific voltage level. While cranking, the cell pack output voltage drops and the current rises. The microcontroller monitors the cell pack temperature, output voltage, and output current and decides to use PWM at a higher duty cycle to allow for the output voltage/current to increase. This allows the engine to crank faster to help with starting. Depending on what the temperature was before or at the start of cranking, how much more to increase the duty cycle on colder crank starts than warmer crank starts is determined. The cell pack could also use and monitor the regulator voltage and current going back into the pack to figure out at what speed the engine is cranking by calculating the pulses. By knowing the speed, it could determine to increase or decrease the PWM duty cycle accordingly.

In some embodiments, the microcontroller monitors the battery cell voltage level on an A/D pin to determine when cells need charging by turning on an output that provides the power to turn on the boost circuit when cells need charging and turning off the boost circuit when the cells are fully charged.

In some embodiments, the microcontroller monitors the battery cell voltage level on an A/D pin to determine when cells need charging by turning on an output that provides the power to turn on the boost circuit when the cell voltage is below a specific determined voltage level and turning off the boost circuit power once the voltage gets up to the specified voltage.

In some embodiments, upon cranking, the micro A/D pin turns on circuitry that will turn on a heating strip or a load resistor to warm up the cells if a large current draw is sensed and the cell temperature is below a specific temperature. Depending on the current draw that is required from the heating element, the microcontroller continues to check periodically the cell temperature and warm the pack to a temperature so it is pre-warmed prior to starting.

At least one of the various controllers described herein may be implemented as a general-purpose processor, an application specific integrated circuit (ASIC), one or more field programmable gate arrays (FPGAs), a digital-signal-processor (DSP), a group of processing components, or other suitable electronic processing components. In one embodiment, at least one of the controllers includes memory and a processor. The memory is one or more devices (e.g., RAM, ROM, Flash Memory, hard disk storage, etc.) for storing data and/or computer code for facilitating the various processes described herein. The memory may be or include non-transient volatile memory or non-volatile memory. The memory may include database components, object code components, script components, or any type of information structure for supporting the various activities and information structures described herein. The memory may be communicably connected to the processor and provide computer code or instructions to the processor for executing the processes described herein. The processor may be implemented as a general-purpose processor, an application specific integrated circuit (ASIC), one or more field programmable gate arrays (FPGAs), a digital-signal-processor (DSP), a group of processing components, or other suitable electronic processing components.

It is important to note that the construction and arrangement of the elements of the systems and methods as shown in the embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. By way of example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. The order or sequence of any process or method steps may be varied or re-sequenced, according to alternative embodiments. Other substitutions, modifications, changes, and omissions may be made in the design, operating conditions, and arrangement of the preferred and other embodiments without departing from scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, by way of example, instructions and data, which cause a general-purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

What is claimed is:

1. A battery for equipment having a charging system providing a charging voltage, the battery comprising:
a primary power supply;
a secondary power supply; and
a battery management system configured to:
at least one of (a) selectively increase the charging voltage to a boosted voltage and (b) selectively decrease the charging voltage to a bucked voltage, and
provide at least one of the boosted voltage and the bucked voltage to the primary power supply.

2. The battery of claim 1, wherein the primary power supply comprises a plurality of lithium-ion cells.

3. The battery of claim 2, wherein the lithium-ion cells of the primary power supply comprise lithium nickel manganese cobalt oxide cells.

4. The battery of claim 2, wherein the lithium-ion cells of the primary power supply comprise lithium iron phosphate cells.

5. The battery of claim 1, wherein the secondary power supply comprises a plurality of lithium-ion cells.

6. The battery of claim 5, wherein the lithium-ion cells of the secondary power supply comprise lithium nickel manganese cobalt oxide cells.

7. The battery of claim 5, wherein the lithium-ion cells of the secondary power supply comprise lithium iron phosphate cells.

8. The battery of claim 1, wherein the secondary power supply comprises at least one capacitor.

9. The battery of claim 1, wherein the battery has a U1 form factor.

10. The battery of claim 1, wherein the battery management system is further configured to reduce an output voltage provided by the primary power supply to a reduced output voltage and provide the reduced output voltage to the equipment.

11. The battery of claim 1, wherein the battery management system is further configured to discharge the secondary power supply when the secondary power supply reaches a charge threshold.

12. A battery for equipment having a charging system providing a charging voltage, the battery comprising:
a primary power supply including a plurality of lithium-ion cells and having a charge capacity;
a secondary power supply; and
a battery management system comprising:
a charging voltage compensation module configured to compensate for a difference between the charging voltage and the charge capacity of the primary power supply.

13. The battery of claim 12, wherein the battery management system further comprises an output voltage compensation module configured to reduce an output voltage provided by the primary power supply to a reduced output voltage and provide the reduced output voltage to the equipment.

14. The battery of claim 13, wherein the battery management system further comprises a secondary power supply discharge module configured to discharge the secondary power supply when the secondary power supply reaches a charge threshold.

15. The battery of claim 12, wherein the battery management system further comprises a secondary power supply discharge module configured to discharge the secondary power supply when the secondary power supply reaches a charge threshold.

16. The battery of claim 12, wherein the lithium-ion cells of the primary power supply comprise lithium nickel manganese cobalt oxide cells.

17. The battery of claim 12, wherein the lithium-ion cells of the primary power supply comprise lithium iron phosphate cells.

18. The battery of claim 12, wherein the secondary power supply comprises a plurality of lithium-ion cells.

19. The battery of claim 12, wherein the secondary power supply comprises at least one capacitor.

20. The battery of claim 12, wherein the battery has a U1 form factor.
